(19) United States
(12) Patent Application Publication
(10) Pub. No.: US 2004/0119931 A1
(43) Pub. Date: Jun. 24, 2004

(54) Alignment method for ferroelectric liquid crystal material and liquid crystal display device using the same

(75) Inventors: Heume Il Baek, Seoul (KR); Gi Hong Kim, Kyounggi-do (KR)

Correspondence Address: MORGAN LEWIS & BOCKIUS LLP, 1111 PENNSYLVANIA AVENUE NW, WASHINGTON, DC, 20004, US

(73) Assignee: LG.PHILIPS LCD CO., LTD.

(21) Appl. No.: 10/608,187

(22) Filed: Jun. 30, 2003

(30) Foreign Application Priority Data
Dec. 21, 2002 (KR) P2002-82062

(51) Int. Cl. C09K 19/02

(52) U.S. Cl. 349/172

(57) ABSTRACT

An electric field alignment method of a ferroelectric liquid crystal display device includes connecting a plurality of thin film transistors arranged along a first direction to a plurality of data lines in an offset configuration between adjacent data lines, supplying a turn-ON voltage at a level greater than a threshold voltage of the thin film transistors during an electric field alignment of ferroelectric liquid crystal material of the ferroelectric liquid crystal display device at least more than two successive times to a plurality of gate lines arranged along a second direction, and supplying voltages of opposite polarity to the adjacent data lines during the electric field alignment while maintaining a voltage of a ferroelectric liquid crystal cell of the ferroelectric liquid crystal display device during the electric field alignment.

The present invention claims the benefit of Korean Patent Application No. P2002-82062 filed in Korea on Dec. 21, 2002, which is hereby incorporated by reference.

### BACKGROUND OF THE INVENTION

1. Field of the Invention

The present invention relates to an alignment method and a display device, and more particularly to an alignment method for ferroelectric liquid crystal material and a liquid crystal display device using the same.

2. Description of the Related Art

In general, a liquid crystal display (LCD) device displays images by adjusting light transmittance according to video signals, controlling an arrangement state of liquid crystal material, and applying an electric field to liquid crystal material corresponding to video signals. The LCD device includes a liquid crystal panel having a liquid crystal material injected between two glass substrates, a light source module (i.e., backlight device) for radiating light onto the liquid crystal panel, a structure comprised of a frame and a chassis for integrally affixing the liquid crystal panel and the light source module as a single body, and a printed circuit board (PCB) for supplying a driving signal to the liquid crystal panel.

A fabrication process of the LCD device is divided into steps of substrate cleaning, substrate patterning, substrate bonding, liquid crystal material injection, and driving circuit mounting. During the substrate cleaning process, a fabricator removes impurities on surfaces of the substrate used to form the liquid crystal panel using the cleaning agents. The substrate patterning process is divided into steps of an upper glass substrate patterning and a lower glass substrate patterning. On the upper glass substrate of the liquid crystal panel, there are formed a color filter, a common electrode, and a black matrix, and on the lower glass substrate of the liquid crystal panel there are formed signal wirings of data and gate lines. In addition, thin film transistors (TFTs) are formed at intersections of the gate and data lines and pixel electrodes are formed in pixel regions of the lower substrate. The substrate bonding/liquid crystal injection processes include steps of rubbing and spreading alignment films on the substrates of the liquid crystal panel, adhering a polarizer on each of the upper and lower glass substrates, bonding the upper and lower glass substrates together using sealant, injecting liquid crystal material inbetween the upper and lower substrates, and sealing a liquid crystal injection hole formed in the sealant.

During the driving circuit mounting process, the fabricator connects a carrier package (TCP) to a pad part formed on the lower glass substrate that includes a gate driver integrated circuit and a data driver integrated circuit. The gate and data driver integrated circuits may be mounted directly on the lower glass substrate using a chip-on-glass (COG).

In addition, the fabrication process includes a module construction process for constructing the liquid crystal panel, the light source module, and the PCB as one body. In the module construction process, the PCB, the light source module, and the liquid crystal panel are stacked from a bottom in a cavity within a main frame, and a top case is constructed to the main frame so that the side of the main frame and the edge of the liquid crystal panel may be enclosed. In addition, a bottom case locating between the main frame and the top case and enclosing the bottom of the main frame is constructed to the main frame. An input stage of the TCP is connected to an output pad of the PCB, and an output stage is connected to signal wiring pad of the liquid crystal panel. The light source module includes a cold-cathode lamp, a light guide panel, an optical prism sheet, and a diffusion plate all stacked between a light guide panel and a liquid crystal panel.

The liquid crystal material used in the liquid crystal display has an intermediate state between solid and liquid states having mobility and elasticity properties. Presently, the liquid crystal material supplied to the liquid crystal display is a twisted nematic mode (TN mode). However, the TN mode has a problem in that response speed is low and viewing-angle is narrow. Accordingly, a ferroelectric liquid crystal (FLC) material is advantageous in that the response speed is high and the viewing-angle is wide. The ferroelectric liquid crystal material has a layered structure, wherein electric and magnetic properties are similar. In addition, the ferroelectric liquid crystal material is driven in a common plane by rotating along a virtual cone in response to an applied electric field. Furthermore, the ferroelectric liquid crystal has permanent polarization, wherein polarization is maintained without the application of the electric field. For example, when an external electric field is applied to the ferroelectric liquid crystal material, the ferroelectric liquid crystals rapidly rotate due to the interaction of the applied external field and the spontaneous polarization of the ferroelectric liquid crystal material. Accordingly, the response speed of the ferroelectric liquid crystal material is hundreds or thousands of times faster than the response speeds of other mode liquid crystal materials. Furthermore, since the ferroelectric liquid crystal material has an in-plane-switching property, wide viewing angles may be achieved without the use of special electrode structures or compensation films. The ferroelectric liquid crystal material may be classified into V-Switching Mode and a Half V-Switching Mode according to a characteristic reaction in response to a polarity of an electric field.

In the ferroelectric liquid crystal cell of the V-Switching Mode, as an operating temperature is lowered, a thermodynamical phase transition occurs wherein:

a isotropic→a smectic A phase(SA)→a smectic X phase (Sm X*)→a crystal.

Here, the isotropic refers to a state where liquid crystal molecules have neither a direction nor a location order, and the smectic A phase referes to a state where the liquid crystal molecules are divided into a virtual layer and are arranged vertically on the virtual layer and have a symmetry about up and down directions. The Smectic X phase refers to a intermediate state between the smectic A phase and the crystal phase.

FIG. 1. is a graph showing voltage vs. transmittance characteristics of a ferroelectric liquid crystal material of a V-Switching Mode according to the related art. In FIG. 1, a ferroelectric liquid crystal cell of a V-Switching Mode in which the liquid crystal molecules are phase-transmitted to the smectic X phase improves light transmittance of incidence light by changing an arrangement state responding to an external voltage of a positive polarity (+V) and an external voltage of a negative polarity (−V). Accordingly, the V-Switching Mode has an advantage of high response speed characteristics and wide viewing angle characteristics, but is disadvantageous in that an effective power to drive a liquid crystal cell is high because a spontaneous polarization value is large, and a capacitance of a storage capacitor in order to maintain a data voltage becomes large. Accordingly, if the V-Switching Mode is applied to a liquid crystal display device, an aperture ratio becomes low since consumption power of the liquid crystal display device and electrode area of an auxiliary capacitor becomes large.

FIG. 2 is a diagram showing a phase transition process of a ferroelectric liquid crystal material of a Half V-Switching Mode according to the related art. A Half V-Switching Mode has an advantage of high response speed characteristics and wide viewing angle characteristics, and has a low capacitance. In FIG. 2, the phase transition of the ferroelectric liquid crystal material is dependent upon a transition temperature. For example, if the ferroelectric liquid crystal material is below the transition temperature (Tni), then the phase transitions from the isotropic to the nematic phase (N*). Similarly, if the ferroelectric liquid crystal material is below the transition temperature (Tsn), then the phase transitions from the nematic phase (N*) to the smectic C phase (Sm C*). Next, if the ferroelectric liquid crystal material is below the transition temperature (Tcs), then the phase transitions from the smectic C phase to the crystal. Accordingly, as the temperature of the the ferroelectric liquid crystal material is lowered, the thermodynamical phase transitions are:

the isotropic→the nematic (N*)→the smectic C phase(Sm C*)→the crystal.

FIG. 3 is a diagram showing molecule arrangement changes according to electric field alignment of a Half V-Switching Mode according to the related art. In FIG. 3, a ferroelectric liquid crystal material is injected into a cell arranged in parallel with an initial temperature of the isotropic without the direction and location order. If this temperature of the isotropic is lowered to a fixed temperature, the ferroelectric liquid crystal material transitions into the nematic phase (N*) arranged parallel to a rubbing direction. In the nematic phase (N*), if the temperature is gradually lowered and a sufficient electric field is applied to the liquid crystal cell, the ferroelectric liquid crystal material of the nematic phase (N*) transitions to the smectic phase (C*) and the spontaneous polarization direction of the ferroelectric liquid crystal material is arranged coincidentally with a direction of the electric field formed inside the liquid crystal cell.

Accordingly, the spontaneous polarization direction of the ferroelectric liquid crystal material coincides with the direction of the applied electric field and the ferroelectric liquid crystal material has an uniform alignment. Conversely, without the electric field alignment process, the two molecular arrangements of the layers are different and appear randomly, wherein phase-transitioning occurs from the nematic phase (N*) to the smectic C phase (Sm*C). If a bistable state in which the molecular arrangement of the ferroelectric liquid crystal material is random, then uniform control of the ferroelectric liquid crystal material becomes difficult. Thus, the ferroelectric liquid crystal cell of the Half V-Mode should be arranged at a monostable state by phase-transitioning the ferroelectric liquid crystal material from the nematic phase (N*) to the smectic C phase (Sm C*) by applying several low DC voltages, as the temperature of the ferroelectric liquid crystal material is lowered. In FIG. 3, the symbol “ [symbol] ” represents the electric field direction and the spontaneous polarization direction of the ferroelectric liquid crystal material coinciding with the direction that enters vertically from an observer.

The electric field alignment of the ferroelectric liquid crystal cell of the V-Switching Mode is executed after substrate bonding and liquid crystal injection processes during the fabrication process described above. Upon the electric field alignment, in a state where the data lines of the liquid crystal panel are commonly connected to shorting bars, the voltage is applied. Similarly, in a state where the gate lines are commonly connected to shorting bars different from the shorting bars of the data lines, a scan voltage set at a value more than a threshold voltage of the TFT is applied to the gate lines. In addition, a common voltage (Vcom) is supplied to a common electrode of an upper glass substrate, and about several DC voltages are applied to the ferroelectric liquid crystal material by a common voltage supplied to the common electrode and a pixel voltage supplied to a pixel electrode through the data lines.

FIGS. 4A and 4B are graphs showing voltage vs. transmittance characteristics of a Half V-Switching Mode according to the related art. In FIG. 4A, a ferroelectric liquid crystal cell of a Half V-Switching Mode allows transmission of incident light by converting the polarization direction of the incident light to 90° only when a positive voltage (+V) is applied. In FIG. 4B, a ferroelectric liquid crystal cell of a Half V-Switching Mode allows transmission of incident light by maintaining the polarization direction of the incident light when a negative voltage (−V) is applied. Accordingly, the light transmittance increases in proportion to the positive electric field intensity and maintains the maximum value if the positive electric field intensity increases to more than the fixed threshold value. On the contrary, if the ferroelectric liquid crystal of the Half V-Switching Mode cell is aligned under electric field by the voltage of the positive polarity (+V) or the electric field of the positive polarity, the ferroelectric liquid crystal cell of the Half V-Switching Mode, as shown in FIG. 4B, transmits the incident light only when the negative voltage (−V) is applied and cuts-off the incident light beam when the positive voltage (+V) is applied.

FIG. 5 is a diagram showing responses of ferroelectric liquid crystal material of a Half V-Switching Mode according to the related art. In FIG. 5, if the ferroelectric liquid crystal cell of the Half V-Switching Mode is aligned by an external electric field of the negative polarity (E(−)), then the spontaneous polarization direction (Ps) of the ferroelectric liquid crystal material is uniformly aligned along a direction coinciding with the external electric field of the negative polarity ((E−)). After the electric field has been aligned, if the external electric field of the positive polarity (E(+)) is applied to the ferroelectric liquid crystal cell of the Half V-Switching Mode, an arrangement of the ferroelectric liquid crystal material is changed and a spontaneous polarization direction (Ps) coincides with the external electric field of the positive polarity (E(+)). Accordingly, the polarization direction of the incident light from a lower plate of the liquid crystal display device is changed to the polarization direction of an upper polarizer by the ferroelectric liquid crystal material such that the incident light is transmitted through the upper plate. On the other hand, if the external electric field of the negative polarity (E(−)) is applied or the external electric field is not applied to the ferroelectric liquid crystal cell of the Half V-Switching Mode, the arrangement of the ferroelectric liquid crystal material maintains an initial arrangement state, the incident light is cut-off, and the ferroelectric liquid crystal material maintains the polarization direction.

However, the ferroelectric liquid crystal cell has a problem in that the initial alignment direction may be altered due to physical impact since a cell gap is relatively low, i.e., about 1.2 μm. Accordingly, in a ferroelectric liquid crystal display device in which the initial electric field is disposed after the processes of substrate bonding and liquid crystal material injection, the initial electric field alignment is likely to be altered during module construction processes in which deformation of the substrates occurs frequently. In order to restore the electric field alignment, the fabricator must separate the TCP from the liquid crystal panel and reconnect the electric field alignment voltage source to each signal wiring. Accordingly, a method has not been developed that can restore the initial alignment in the ferroeletric liquid crystal panel. In addition, if a fabricator aligns the entire ferroelectric liquid crystal cell under an electric field that is identical to the electric field used to displays images, the viewing angle of the ferroelectric liquid crystal display device narrows since an observer will see the light only along a direction of either a long-axis or a short-axis of the liquid crystal molecules upon rotation of the liquid crystal molecules. Thus, color shifting occurs according to a location of the observer and picture quality significantly decreases.

### SUMMARY OF THE INVENTION

Accordingly, the present invention is directed to an alignment method for ferroelectric liquid crystal material and a liquid crystal display device using the same that substantially obviates one or more of the problems due to limitations and disadvantages of the related art.

An object of the present invention is to provide a method of aligning ferroelectric liquid crystal material capable of restoring an alignment direction of a ferroelectric liquid crystal cell.

Another object of the present invention is to provide a liquid crystal display device having a ferroelectric liquid crystal material capable of restoring an alignment direction of a ferroelectric liquid crystal cell.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an electric field alignment method of a ferroelectric liquid crystal display device includes connecting a plurality of thin film transistors arranged along a first direction to a plurality of data lines in an offset configuration between adjacent data lines, supplying a turn-ON voltage at a level greater than a threshold voltage of the thin film transistors during an electric field alignment of ferroelectric liquid crystal material of the ferroelectric liquid crystal display device at least more than two successive times to a plurality of gate lines arranged along a second direction, and supplying voltages of opposite polarity to the adjacent data lines during the electric field alignment while maintaining a voltage of a ferroelectric liquid crystal cell of the ferroelectric liquid crystal display device during the electric field alignment.

In another aspect, an electric field alignment method of a ferroelectric liquid crystal display device includes connecting a plurality of thin film transistors arranged along a first direction to a plurality of data lines arranging in an offset configuraton between adjacent data lines, supplying a voltage below a threshold voltage of the thin film transistors to a plurality of gate lines during an electric field alignment of ferroelectric liquid crystal material of the ferroelectric liquid crystal display device, and supplying voltages of opposite polarity to adjacent data lines during the electric field alignment while maintaining a voltage of a ferroelectric liquid crystal cell of the ferroelectic liquid crystal display device during the electric field alignment.

In another aspect, an electric field alignment method of a ferroelectric liquid crystal display device includes connecting a plurality of thin film transistors arranged along a first direction to a plurality of data lines in an offset configuration adjacent data lines, maintaining a plurality of gate lines in an electrically floating state during an electric field alignment of a ferroelectric liquid crystal material of the ferroelectric liquid crystal display device, and supplying voltages of opposite polarity to the adjacent data lines during the electric field alignment while maintaining a voltage of a ferroelectric liquid crystal cell of the ferroelectric liquid crystal display device during the electric field alignment.

In another aspect, a ferroelectric liquid crystal display device includes a liquid crystal panel having a plurality of data and gate lines and a plurality of thin film transistors arranged along a first direction in an offset configuration between adjacent data lines, a gate driving circuit for supplying a turn-ON voltage at least more than two successive times to the plurality of gate lines, the turn-ON voltage set at a level above a threshold voltage of the thin film transistors during an electric field alignment of ferroelectric liquid crystal material, and a data driving circuit for controlling opposite polarity voltages supplied to the adjacent data lines during the electric field alignment while maintaining a voltage supplied to ferroelectric liquid crystal cells during the electric field alignment.

In another aspect, a ferroelectric liquid crystal display device includes a liquid crystal panel having a plurality of data and gate lines and a plurality of thin film transistors arranged along a first direction in an offset configuration between adjacent data lines, a gate driving circuit for supplying a voltage below a threshold voltage of the thin film transistors to the gate lines during an electric field alignment of ferroelectric liquid crystal material of the display device, and a data driving circuit for controlling opposite polarity voltages supplied to the adjacent data lines during the electric field alignment while maintaining a voltage supplied to a ferroelectric liquid crystal cell during the electric field alignment.

In another aspect, a ferroelectric liquid crystal display device includes a liquid crystal panel having a plurality of data and gate lines and a plurality of thin film transistors arranged along a first direction in an offset configuration between adjacent data lines, and a data driving circuit for controlling opposite polarity voltages supplied to the adjacent data lines during an electric field alignment while maintaining a voltage supplied to a ferroelectric liquid crystal cell during the electric field alignment, wherein the gate lines remain electrically floating during the electric field alignment.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a graph showing voltage vs. transmittance characteristics of a ferroelectric liquid crystal material of a V-Switching Mode according to the related art;

FIG. 2 is a diagram showing a phase transition process of a ferroelectric liquid crystal material of a Half V-Switching Mode according to the related art;

FIG. 3 is a diagram showing molecule arrangement changes according to electric field alignment of a Half V-Switching Mode according to the related art;

FIGS. 4A and 4B are graphs showing voltage vs. transmittance characteristics of a Half V-Switching Mode according to the related art;

FIG. 5 is a diagram showing responses of ferroelectric liquid crystal material of a Half V-Switching Mode according to the related art;

FIG. 6 is a block schematic diagram of an exemplary liquid crystal display device according to the present invention;

FIG. 7 is a graph showing current characteristics between source and drain voltages of a TFT according to a gate voltage according to the present invention;

FIG. 8 is a waveform diagram showing low voltage holding characteristics of an exemplary ferroelectric liquid crystal cell of a Half V-Switching Mode according to the present invention;

FIG. 9 is a block schematic diagram of another exemplary liquid crystal display device according to the present invention;

FIG. 10 is a plan view of exemplary TFTs formed in the liquid crystal panel of FIG. 9 according to the present invention;

FIG. 11 is a plan view of additional exemplary TFTs formed in the liquid crystal panel of FIG. 9 according to the present invention;

FIG. 12 is a block schematic diagram of an exemplary data driving circuit of the liquid crystal panel of FIG. 9 according to the present invention;

FIG. 13 is a schematic circuit diagram of an exemplary digital-to-analog converter of the data driving circuit of FIG. 12 according to the present invention;

FIG. 14 is an exemplary waveform diagram showing a gate voltage generated from the gate driving circuit of FIG. 9, and a voltage change of ferroelectric liquid crystal cell according to the gate voltage according to the present invention;

FIG. 15 is an exemplary schematic diagram showing spontaneous polarization directions of ferroelectric liquid crystal cells of the TFT arrangement of FIG. 10 according to the present invention;

FIG. 16 is another exemplary schematic diagram showing spontaneous polarization directions of ferroelectric liquid crystal cells of the TFT arrangement of FIG. 11 according to the present invention; and

FIG. 17 is a schematic circuit diagram showing an exemplary electric field alignment method of a ferroelectric liquid crystal display device according to the present invention.

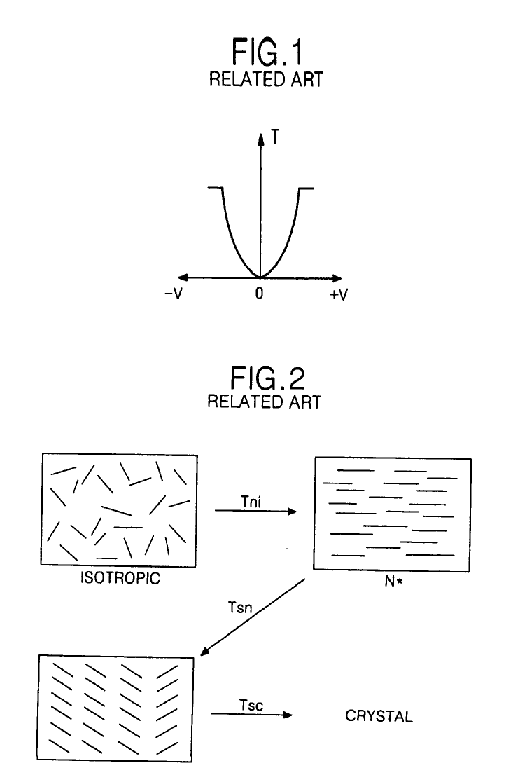

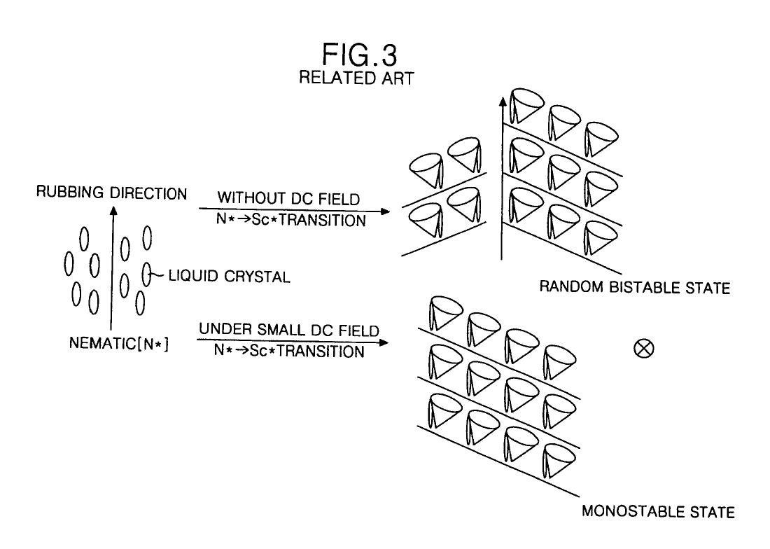

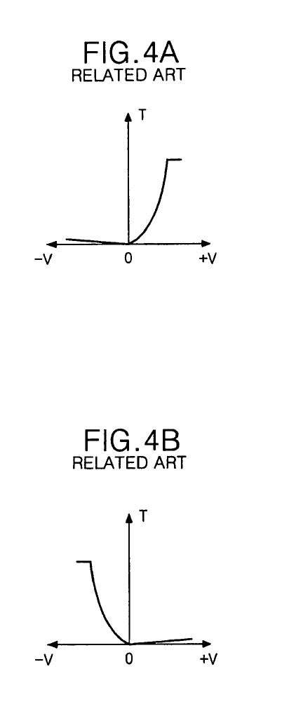

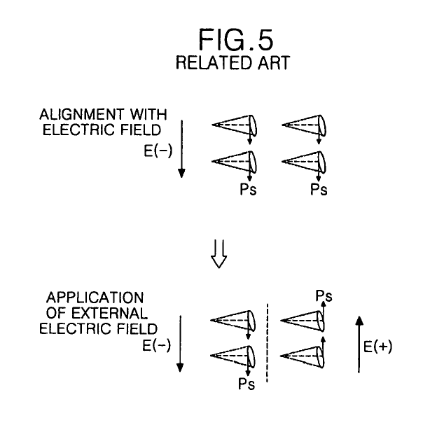

### DETAILED DESCRIPTION OF THE PREFERRED EMBODIMENTS

Reference will now be made in detail to the preferred embodiments of the present invention, examples of which are illustrated in the accompanying drawings.

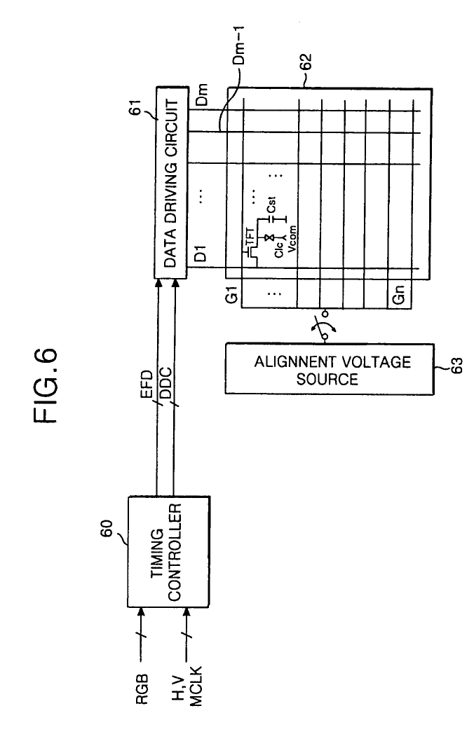

FIG. 6 is a block schematic diagram of an exemplary liquid crystal display device according to the present invention. In FIG. 6, an electric field alignment apparatus of a ferroelectric liquid crystal display may include a liquid crystal panel 62 where an (m×n) matrix configuration of ferroelectric liquid crystal cells (C1c) may be arranged, an m-number of data lines (D1 to Dm) and an n-number of gate lines (G1 to Gn) may be arranged to cross each other, a TFT disposed at each of the crossing regions of the data and gate lines, a data driving circuit 61 for supplying data to the data lines (D1 to Dm) of the liquid crystal panel 62, an alignment voltage source 63 for supplying a voltage below a threshold voltage of the TFTs to the gate lines (G1 to Gn), and a timing controller 60 for controlling the data driving circuit 61.

The liquid crystal panel 62 may include a ferroelectric liquid crystal material of a Half V-Switching Mode, wherein the ferroelectric liquid crystal material may be injected between two glass substrates. The data lines (D1 to Dm) and the gate lines (G1 to Gn) may be formed on a lower glass substrate of the liquid crystal panel 62. In addition, a gate electrode of the TFT may be connected to a corresponding one of the gate lines (G1 to Gn), a source electrode of the TFT may be connected to a corresponding one of the data lines (D1 to Dm), and a drain electrode of the TFT may be connected to a pixel electrode of ferroelectric liquid crystal cell (C1c)

An alignment voltage source 63 may supply a voltage below threshold voltage of the TFT to the gate lines (G1 to Gn) to establish electric field alignment of the ferroelectric liquid crystal material. If the voltage is supplied to the gate electrode of TFT and the voltage is supplied to the data lines (D1 to Dm), then a leakage current may be generated between the source and drain electrodes of the TFT, and the voltage may be supplied to a pixel electrode of the ferroelectric liquid crystal cell (C1c). For example, if the threshold voltage of the TFT is supplied to the gate electrode of the TFT, a channel region is formed between the source and drain electrodes. Conversely, if an OFF voltage of the TFT is supplied to the gate electrode of the TFT, then the channel region is nearly cut-OFF between the source and drain electrodes.

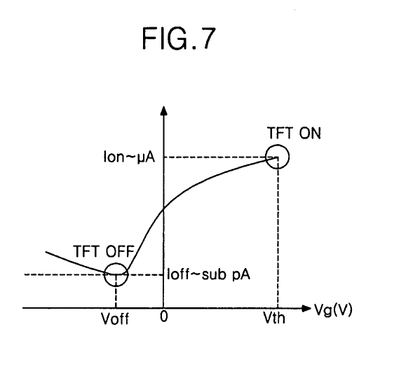

FIG. 7 is a graph showing current characteristics between source and drain voltages of a TFT according to a gate voltage according to the present invention. An alignment voltage source 63 may supply a voltage below threshold voltage of the TFT to the gate lines (G1 to Gn) to establish electric field alignment of the ferroelectric liquid crystal material. If the voltage is supplied to the gate electrode of the TFT and the voltage is supplied to the data lines (D1 to Dm), then a leakage current may be generated between the source and drain electrodes of the TFT, and the voltage may be supplied to a pixel electrode of the ferroelectric liquid crystal cell (C1c). For example, if the threshold voltage of the TFT is supplied to the gate electrode of the TFT, a channel region is formed between the source and drain electrodes. Conversely, if an OFF voltage of the TFT is supplied to the gate electrode of the TFT, then the channel region is nearly cut-OFF between the source and drain electrodes.

In FIG. 7, a threshold voltage of a TFT may be about 20V and an OFF voltage of the TFT may be about −5V, then an alignment voltage source 63 (in FIG. 6) may supply a voltage more than −5V and below 20V to the gate electrode.

In FIG. 6, during normal driving of the liquid crystal panel 62, the alignment voltage source 63 may be removed and a gate driving circuit (not shown) may be connected to the gate lines (G1 to Gn). The gate driving circuit may be connected to the gate lines (G1 to Gn) during normal driving, and may sequentially supply scan voltages set at a level more than the threshold voltage of the TFT to the gate lines (G1 to Gn), thereby sequentially turning ON corresponding ones of the TFTs.

The data driving circuit 61 may convert digital data to analog voltages in response to a data control signal (DDC) received from a timing controller 60, thereby supplying the analog voltages to the data lines (D1 to Dm). For example, the digital data (EFD) may be set to the digital value corresponding to the analog voltage necessary for the electric field alignment, and may be generated from the timing controller 60 during initial electric field alignment or when restoring an alignment. The data driving circuit 61 may control the voltage supplied to the data lines (D1 to Dm) so that the voltage charged to each liquid crystal cell (C1c) upon the electric field alignment may be kept constant, and may control a polarity of the data voltage using one of a column inversion method, a line inversion method, or a dot inversion method during the normal driving for displaying images.

The timing controller 60 may supply the digital data (EFD) necessary for the electric field alignment to the data driving circuit 61 upon the electric field alignment or when restoring the alignment. In addition, the timing controller may generate the data control signal (DDC) for controlling the data driving circuit 61 using a vertical/horizontal synchronous signal (V,H) and a main clock signal (MCLK). The data control signal (DDC) may include a source start pulse (SSP), a source shift clock pulse (SSC), a source output enable signal (SOE), and a polarity signal (POL). Furthermore, the timing controller 60 may supply R, G, and B digital video data to the data driving circuit 61 upon normal driving, may generate the data control signal (DDC) for controlling the data driving circuit 61 and a gate control signal (not shown) by which the gate driving circuit (not shown) sequentially generates the scan pulse, and may control the data driving circuit 61 and the gate driving circuit (not shown).

In addition, the gate line (G1 to Gn) may maintain an electrically floating state, wherein a voltage is not supplied upon the electric field alignment of the ferroelectric liquid crystal cell. Accordingly, the alignment voltage source 63 may not be used and the voltage on the data lines (D1 to Dm) may be supplied to the pixel electrode of the liquid crystal cell by the leakage current of the TFT.

In FIG. 6, the liquid crystal panel 62 may include a storage capacitor Cst by which the ferroelectric liquid crystal cell may maintain the data voltage connected to the ferroelectric liquid crystal cell C1c. The storage capacitor (Cst) may be formed between the ferroelectric liquid crystal cell connected to a k^{th} line (k is a positive integer between 1 and m) and a (k−1)^{th} gate line (G1 to Gn−1), and may be connected to the ferroelectric liquid crystal cell C1c connected to k^{th} line and to a common line.

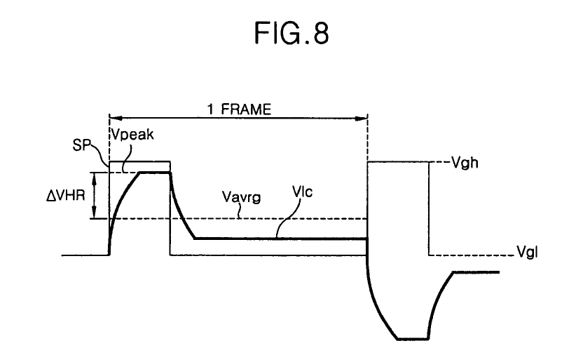

FIG. 8 is a waveform diagram showing low voltage holding characteristics of an exemplary ferroelectric liquid crystal cell of a Half V-Switching Mode according to the present invention. Since the electric field is applied to the ferroelectric liquid cell C1c by using the leakage current of the TFT, the response characteristics of the ferroelectric liquid crystal are improved. However, it may be difficult to sufficiently supply the voltage necessary for the electric field alignment to the ferroelectric liquid crystal cell C1c. More specifically, the ferroelectric liquid crystal cell C1c abruptly discharges a charged voltage after a peak voltage of the data voltage is charged in the instant that a scan pulse (SP) is changed to the high logic. If the voltage of the ferroelectric liquid crystal cell C1c abruptly discharges, an average voltage (Vavrg) of the liquid crystal cell becomes very low. Although the leakage current of the TFT is small, if a voltage of the data line (D1 to Dn) increases, the sufficient voltage is supplied to the ferroelectric liquid crystal cell C1c. However, when the data driving circuit 61 uses an integrated circuit for normal driving displaying images, since only an analog voltage corresponding to a video data is output, it is difficult to output additional voltage.

In FIG. 8, ΔVHR represents a difference between a peak voltage (Vpeak) supplied to the ferroelectric liquid crystal cell C1c and an average voltage (Vavrg) of the liquid crystal cell during one frame period as a voltage holding ratio characteristic. Accordingly, in the low voltage holding characteristic of the ferroelectric liquid crystal cell, if the voltage is supplied to the ferroelectric liquid crystal cell C1c only with the leakage current of TFT, it is difficult that the voltage necessary for the electric field alignment is sufficiently supplied to the ferroelectric liquid crystal cell C1c.

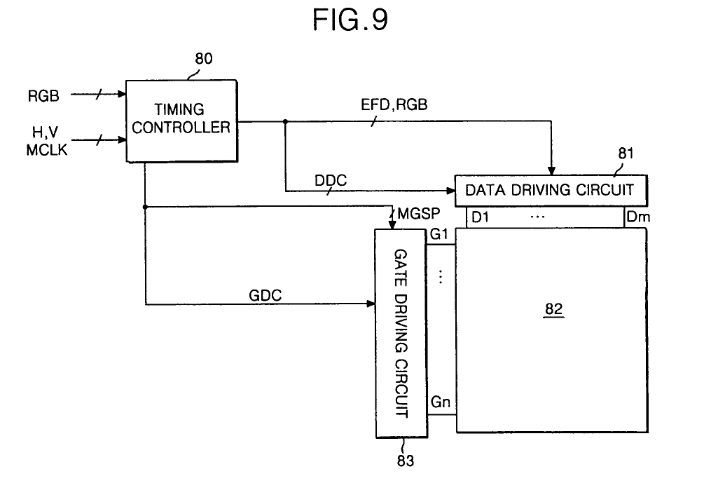

FIG. 9 is a block schematic diagram of another exemplary liquid crystal display device according to the present invention. In FIG. 9, an electric field apparatus of a ferroelectric liquid crystal display device may include a liquid crystal panel 82 where TFTs are arranged in an offset configuration (i.e., zigzag pattern) between two data lines along a direction of a data line, a data driving circuit 81 for supplying the data using a column inversion method to the data lines (D1 to Dm) of the liquid crystal panel 82, a gate driving circuit 83 for sequentially supplying a voltage more than a threshold voltage of the TFTs to the gate lines (G1 to Gn) in response to a multiple gate start pulse (MGSP) upon electric field alignment, and a timing controller 80 for controlling the data driving circuit 81 and the gate driving circuit 83.

Although not shown, the liquid crystal panel 82 include two glass substrates and a ferroelectric liquid crystal material injected therebetween, wherein the data lines (D1 to Dm) and the gate lines (G1 to Gn) may be formed on the lower glass substrate of the liquid crystal panel 82 to cross each other. The TFTs are each formed at crossings of the data lines (D1 to Dm) and the gate lines (G1 to Gn) to supply data transmitted along the data lines (D1 to Dm) to the liquid crystal cell C1c in response to scan signals transmitted along the gate lines (G1 to Gn). Accordingly, the gate electrode of the TFT may be connected to corresponding ones of the gate lines (G1 to Gn) and the source electrode may be connected to corresponding ones of the data lines (D1 to Dm). In addition, the drain electrode of TFT may be connected to a pixel electrode of the liquid crystal cell C1c.

Although not shown, the upper glass substrate of the liquid crystal panel 82 may include a black matrix, a color filter, and a common electrode. In addition, polarization plates may be provided on the lower and upper glass substrates, and alignment films may be provided on inner surfaces of the lower and upper substrates adjacent to the liquid crystal material for setting a pre-tilt angle of the liquid crystal material. Furthermore, a storage capacitor Cst may be formed in each liquid crystal cell C1c of the liquid crystal panel 82. The storage capacitor Cst may be formed between the pixel electrode of the liquid crystal cell C1c and the gate line of an adjacent liquid crystal cell C1c or may be formed between the pixel electrode of the liquid crystal cell C1c and the common electrode line (not shown). Thus, the storage capacitor Cst may maintain a constant voltage value of the liquid crystal cell C1c.

The ferroelectric liquid crystal material may be injected into liquid crystal panel 82 in which the alignment films of the upper and lower glass substrates may be disposed parallel at the initial temperature of about 100° C. Subsequently, an isotropic ferroelectric liquid crystal may be phase-transitioned to the nematic phase (N*) below the transition temperature (Tni) of about 90° C.˜100° C. from the isotropic phase to the nematic phase (N*). Then, if the temperature is lowered below the transition temperature (Tsn) of about 60° C.˜80° C. to transition from the nematic phase to the smectic C phase (Sm C*), an array of ferroelectric liquid crystal may be transitioned from the nematic phase (N*) to the smectic C phase (Sm C*). Below the transition temperature (Tsn), the ferroelectric liquid crystal may be transitioned from the nematic phase (N*) to the smectic C phase (Sm C*). Accordingly, the data of the column inversion method may be supplied to the data lines (D1 to Dm) by the data driving circuit 81 and the voltage may be set to a level more than the threshold voltage of TFT and may be supplied to the gate lines (G1 to Gn) by the gate driving circuit 83. Thus, the ferroelectric liquid crystal material may be aligned due to the applied electric field.

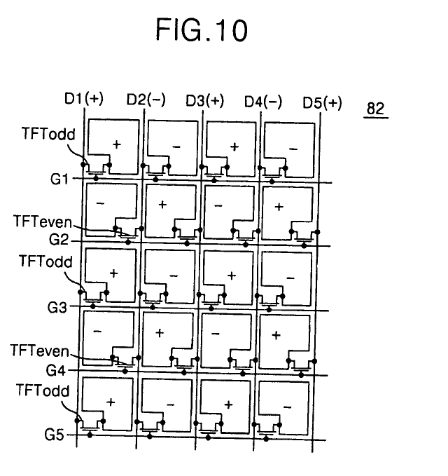

FIG. 10 is a plan view of exemplary TFTs formed in the liquid crystal panel of FIG. 9 according to the present invention. In FIG. 10, when viewed along a data line direction, the TFTs may be arranged in an offset configuration (i.e., zigzag pattern) between two adjacent data lines. For example, the TFTs arranged along the data line direction are divided into odd-numbered TFTs (TFTodd) and even-numbered TFTs (TFTeven), wherein the odd-numbered TFTs (TFTodd) may be connected to odd-numbered data lines (D1, D3, . . . , Dm−1) and the even-numbered TFTs (TFTeven) may be connected to even-numbered data lines (D2, D4, . . . , Dm).

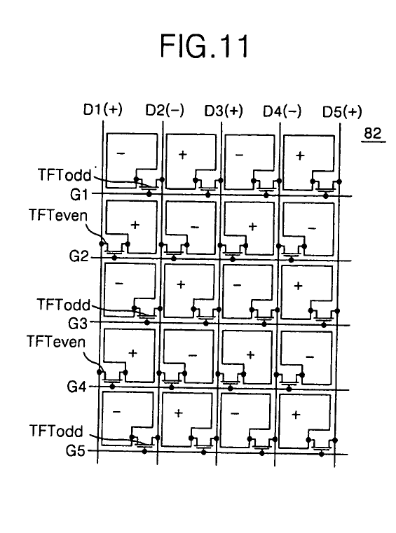

FIG. 11 is a plan view of additional exemplary TFTs formed in the liquid crystal panel of FIG. 9 according to the present invention. In FIG. 11, odd-numbered TFTs (TFTodd) may be connected to even-numbered data lines (D2, D4, . . . , Dm), and even-numbered TFTs (TFTeven) may be connected to odd-numbered data lines (D1, D3, . . . , Dm−1).

If a voltage of mutually contrary polarity is supplied to two adjacent data lines (D1 to Dm), the ferroelectric liquid crystal cells C1c arranged vertically may be aligned under the electric field to the voltage of other polarity according to a location by the arrangement of the TFT, as shown in FIGS. 10 and 11. During the electric field alignment period, each voltage of the ferroelectric liquid crystal cell C1c may be constantly maintained.

In FIG. 9, the timing controller 80 may generate multiple gate start pulses (MGSP) and gate control signals (GDC) for controlling the gate driving circuit 83 by using vertical/horizontal synchronization signals and a clock signal received from a control system (not shown). In addition, the timing controller 80 may generate a data control signal (DDC) for controlling the data driving circuit 81 by using the vertical/horizontal synchronization signals and the clock signal. The gate control signal (GDC) may include a gate shift clock signal (GSC) and a gate output enable signal (GOE). The data control signal (DDC) may include a source start pulse (SSP), a source shift clock signal (SSC), a source output enable signal (SOC), and a polarity signal (POL). In addition, the timing controller 80 may supply the electric field alignment data signal (EFD) to the data driving circuit 81 upon electric field alignment of the ferroelectric liquid crystal material, and may rearrange the R, G, and B digital video data from the control system (not shown) upon normal driving for displaying the R, G, and B video data and may supply the R, G, and B digital video data to the data driving circuit 81.

The data driving circuit 81 may convert the electric field alignment data signal (EFD) received from the timing controller 80 into analog gamma voltage upon the electric field alignment of the ferroelectric liquid crystal material and may control the polarity of the analog gamma voltages supplied to the adjacent data lines (D1 to Dm). Accordingly, the voltage and the polarity supplied to the liquid crystal cell C1c during the electric field alignment period of the ferroelectric liquid crystal material may be constantly maintained. In addition, the data driving circuit 81 may convert the R, G, and B video data into the analog gamma voltages upon normal driving for displaying the R, G, and B video data, and may control the polarity of the analog gamma voltages supplied to adjacent data lines (D1 to Dm). Furthermore, the data driving circuit 81 may convert the polarity of the analog gamma voltages on a frame-by-frame basis.

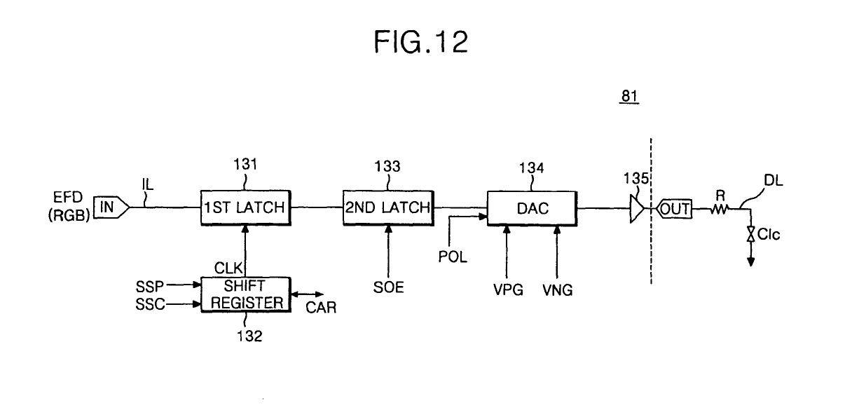

FIG. 12 is a block schematic diagram of an exemplary data driving circuit of the liquid crystal panel of FIG. 9 according to the present invention. In FIG. 12, the data driving circuit 81 may include a shift register 132 connected subordinately between an input line (IL) and the data line (DL), a first latch 131, a second latch 133, a digital-to-analog converter 134 (DAC), and a buffer 135. The shift register 132 may shift a source start pulse (SSP) from the timing controller 80 according to a source shift clock signal (SSC) and may generate a sampling signal. Furthermore, the shift register 132 may shift the source start pulse (SSP) and transmit a carry signal (CAR) to the shift register 132 of a next stage. The first latch 131 may sample the digital electric field alignment data signal (EFD) or the R, G, and B digital video data according to the sampling signal received from the shift register 132, and may then provide the stored data (EFD, RGB). The second latch 133 may latch the stored data (EFD, RGB) received from the first latch 131, and may then simultaneously provide the data of one horizontal line in response to the source output enable signal (SOE) received from the timing controller 80.

The DAC 134 may convert the stored data (EFD, RGB) received from the second latch 133 into a positive analog gamma voltage (VPG) or into a negative analog gamma voltage (VNG) in response to the polarity signal (POL) received from the timing controller 80. The buffer 135 may produce the analog gamma voltages (VPG, VNG) received from the DAC 134 to the data line (DL) without any signal attenuation. In addition, a linear resistance R may be provided between the data driving circuit 81 and the data line (DL).

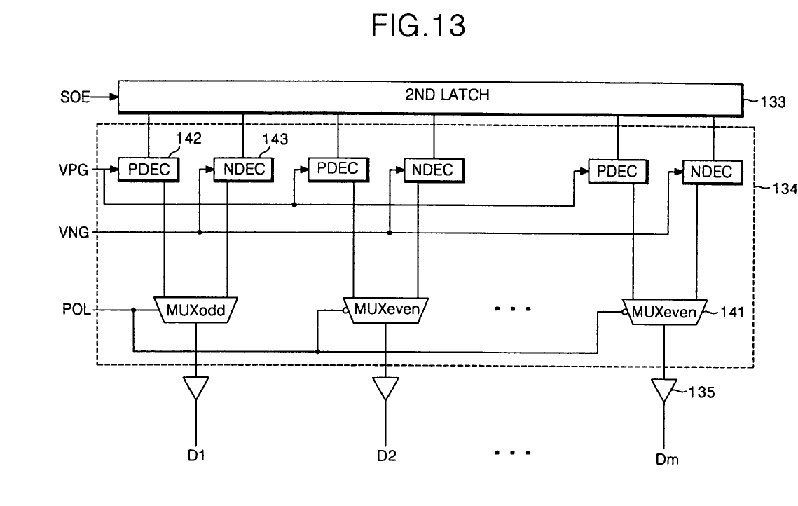

FIG. 13 is a schematic circuit diagram of an exemplary digital-to-analog converter of the data driving circuit of FIG. 12 according to the present invention. In FIG. 13, the DAC 134 of the data driving circuit 81 may include a P-decoder 142 for converting the stored data (EFD,RGB) received from the second latch 133 into the positive analog gamma voltage (VPG), an N-decoder 143 for converting the stored data (EFD,RGB) received from the second latch 133 into the negative analog gamma (VNG), and multiplexers 141 for selecting among the outputs of the P-decoder and N-decoder in order to drive the data lines (D1 to Dm) using a column inversion method. Each multiplexer 141 may select the output of the P-decoder 142 when the polarity signal (POL) is at a high logic value, and may select the output of the N-decoder 143 when the polarity signal is at a low logic value. In addition, odd-numbered multiplexers 141 may be connected to odd-numbered data lines (D1, D3, . . . , Dm−1) and may select the output of the P-decoder 142 and the output of the N-decoder 143 in response to non-inverting signals of the polarity signal (POL). Furthermore, even-numbered multiplexers 141 may be connected to even-numbered data lines (D2, D4, . . . , Dm) and may select the output of the P-decoder 142 and the output of the N-decoder 143 in response to inverting signals of the polarity signal (POL). Accordingly, the voltage of the contrary polarity may be supplied to the odd-numbered data lines (D1, D3, . . . , Dm−1) and to the even-numbered data lines (D2, D4, . . . , Dm).

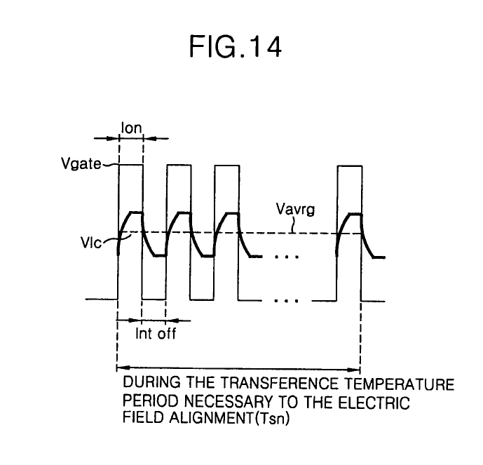

FIG. 14 is an exemplary waveform diagram showing a gate voltage generated from the gate driving circuit of FIG. 9, and a voltage change of a ferroelectric liquid crystal cell according to the gate voltage according to the present invention. In FIG. 14, the reference V1c denotes the voltage of the ferroelectric liquid crystal cell C1c, and the reference Vavrg denotes the average voltage charged to the ferroelectric liquid crystal cell C1c during the electric field alignment. In FIG. 14, the gate driving circuit 83 (in FIG. 9) may include a shift register for generating the scan pulse or the gate voltage (Vgate) set at a level above the threshold voltage (Vth) of the TFT, and a level shifter for shifting the gate voltage (Vgate) or the voltage of the scan pulse to the level apposite for driving of the liquid crystal cell C1c. The gate driving circuit 83 (in FIG. 9) may supply the voltage (Vgate) set to the level above the threshold voltage (Vth) of the TFT to each of the gate lines (G1 to Gn) several hundreds of times during the electric field alignment period of the ferroelectric liquid crystal material in response to the multiple gate start pulses (MGSP) and the gate control signal (GDC) received from the timing controller 80 (in FIG. 9) upon the electric field alignment of the ferroelectric liquid crystal material. It may be preferable that upon the electric field alignment, the gate voltage (Vgate) generated successively from the gate driving circuit 83 may be supplied to the gate lines (G1 to Gn) about ten times or about four-hundred times during the electric field alignment.

If the gate voltage (Vgate) is supplied to the gate lines (G1 to Gn) below ten times during the transition temperature, the voltage maintained in the ferroelectric liquid crystal cell C1c, more specifically a voltage holding ratio (VHR), becomes low. Accordingly, during the electric field alignment, if the gate voltage (Vgate) is supplied to the gate lines (G1 to Gn) below ten times, the electric field necessary for the electric field alignment may not be supplied sufficiently to the ferroelectric liquid crystal cell C1c. During the transition temperature, if the gate voltage (Vgate) is supplied more than four hundred times to the gate lines (G1 to Gn), since the pulse width becomes very short, the ON current of the TFT may not be sufficient. More specifically, if the gate voltage (Vgate) is supplied to the gate lines (G1 to Gn) more than four hundred times during the electric field alignment, it may be difficult to turn ON the TFTs normally. Furthermore, if the gate voltage (Vgate) is supplied to the gate lines (G1 to Gn) more than four hundred times during the electric field alignment, the gate voltage (Vgate) can become distorted due to overshoot and undershoot such that large ripples may be produced.

The ferroelectric liquid crystal cell C1c charges the voltage applied through the data lines (D1 to Dm) and the TFT with the gate driving circuit 83, and the ferroelectric liquid crystal cell C1c is aligned under the electric field by the charged voltage. In addition, the gate driving circuit 83 (in FIG. 9) may supply the scan pulse to the gate lines (G1 to Gn) in response to the multiple gate start pulses (MGSP) and the gate control signal (GDC) received from the timing controller 80 upon normal driving for displaying images, and may select the horizontal liquid crystal cell C1c to which the video data voltage is supplied.

During the electric field alignment, the data driving circuit 81, as shown in FIGS. 10 and 11, may control the polarity of the voltage supplied to adjacent data lines (D1 to Dm). During the electric field alignment period of the ferroelectric liquid crystal cell, the gate driving circuit 83, as shown in FIG. 14, may supply the gate voltage (Vgate) set to a level higher than the threshold voltage (Vth) of the TFT to each gate line (G1 to Gn) several hundred times. A common voltage may be supplied to the common electrode formed on the upper glass substrate of the liquid crystal panel during the electric field alignment.

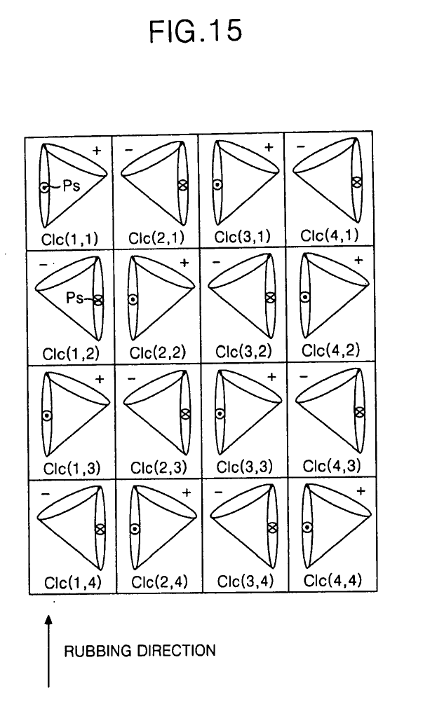

According to the arrangement structure of the TFT, as shown in FIG. 10, during the electric field alignment period, if the positive polarity voltage (+) is supplied to the odd-numbered data lines (D1, D3, . . . , Dm−1) and the negative polarity voltage (−) is supplied to the even-numbered data lines (D2, D4, . . . , Dm), as shown in FIG. 15, the ferroelectric liquid crystal cells (C1c(1,1), C1c(3,1), C1c(2,2), C1c(4,2), C1c(1,3), C1c(3,3), C1c(2,4), C1c(4,4), C1c(1,5), C1c(3,5)) connected to the odd-numbered data lines (D1, D3, . . . , Dm−1) may be uniformly arranged where the spontaneous polarization (PS) direction becomes parallel with the positive electric field direction. Accordingly, the ferroelectric liquid crystal cells (C1c(2,1), C1c(4,1), C1c(1,2), C1c(3,2), C1c(2,3), C1c(4,3), C1c(1,4), C1c(3,4), C1c(2,5), C1c(4,5)) connected to the even-numbered data lines (D2, D4, . . . , Dm) may be uniformly arranged where the spontaneous polarization (PS) direction becomes parallel with the negative electric field direction. Thus, the spontaneous polarization (PS) direction of the liquid crystal cells (C1c(1,1), C1c(3,1), C1c(2,2), C1c(4,2), C1c(1,3), C1c(3,3), C1c(2,4), C1c(4,4), C1c(1,5), C1c(3,5)) aligned under electric field by the positive polarity electric field and the liquid crystal cells (C1c(2,1), C1c(4,1), C1c(1,2), C1c(3,2), C1c(2,3), C1c(4,3), C1c(1,4), C1c(3,4), C1c(2,5), C1c(4,5)) aligned under electric field by the negative electric field becomes contrary to each other. Since the TFTs arranged along the data line direction may be connected to the data lines alternately between two data lines, which may be adjacently offset (i.e., zigzag patterned), the liquid crystal cells (C1c(1,1), C1c(3,1), C1c(2,2), C1c(4,2), C1c(1,3), C1c(3,3), C1c(2,4), C1c(4,4), C1c(1,5), C1c(3,5)) aligned under electric field by the positive polarity electric field and the cells (C1c(2,1), C1c(4,1), C1c(1,2), C1c(3,2), C1c(2,3), C1c(4,3), C1c(1,4), C1c(3,4), C1c(2,5), C1c(4,5)) aligned under electric field by the negative polarity electric field may be arranged alternately. As a result, an observer may view images without color shifting since the light is aligned along a direction of the long and short axis of the ferroelectric liquid crystal molecules in adjacent liquid crystal cells (C1c) irrespective of viewing angle of the liquid crystal display device.

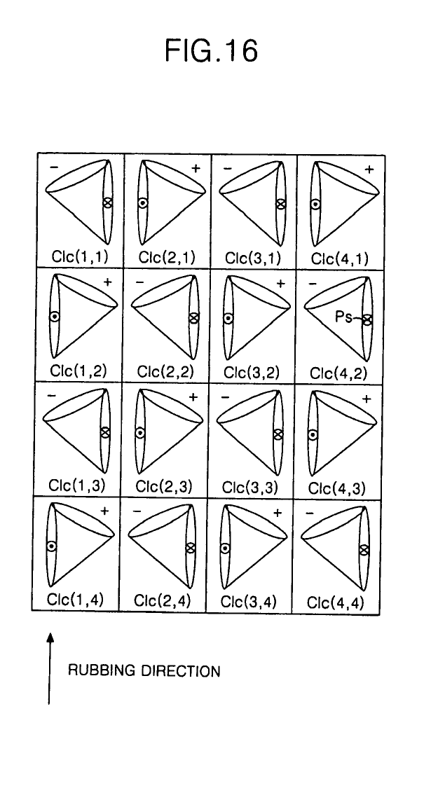

FIG. 16 is another exemplary schematic diagram showing spontaneous polarization directions of ferroelectric liquid crystal cells of the TFT arrangement of FIG. 11 according to the present invention. With respect to the arrangement structure of the TFT, as shown in FIG. 11, during the electric field alignment period, if the positive polarity voltage (+) is supplied to the odd-numbered data lines (D1, D3, . . . , Dm−1) and the negative polarity voltage (−) is supplied to the even-numbered data lines (D2, D4, . . . , Dm), as shown in FIG. 16, the ferroelectric liquid crystal cells (C1c(1,1), C1c(3,1), C1c(2,2), C1c(4,2), C1c(1,3), C1c(3,3), C1c(2,4), C1c(4,4), C1c(1,5), C1c(3,5)) connected to the even-numbered data lines (D2, D4, . . . , Dm) are uniformly arranged where the spontaneous polarization (PS) direction becomes parallel with the negative electric field direction. In addition, the ferroelectric liquid crystal cells (C1c(2,1), C1c(4,1), C1c(1,2), C1c(3,2), C1c(2,3), C1c(4,3), C1c(1,4), C1c(3,4), C1c(2,5), C1c(4,5)) connected to the odd-numbered data lines (D1, D3, . . . , Dm−1) are uniformly arranged where the spontaneous polarization (PS) direction becomes parallel with the positive electric field direction. Accordingly, along the gate and data line directions, the liquid crystal cells (C1c(1,1), C1c(3,1), C1c(2,2), C1c(4,2), C1c(1,3), C1c(3,3), C1c(2,4), C1c(4,4), C1c(1,5), C1c(3,5)) aligned under electric field by the positive polarity electric field and the liquid crystal cells (C1c(2,1), C1c(4,1), C1c(1,2), C1c(3,2), C1c(2,3), C1c(4,3), C1c(1,4), C1c(3,4), C1c(2,5), C1c(4,5)) aligned under electric field by the negative electric field are arranged alternately and the spontaneous polarization (PS) of the ferroelectric liquid crystal cells are inverted alternately in the data line direction and in the gate line direction.

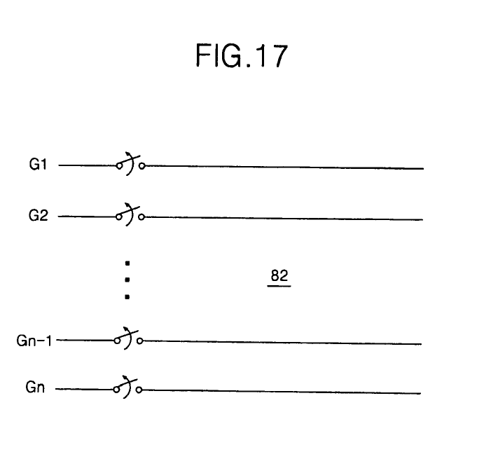

FIG. 17 is a schematic circuit diagram showing an exemplary electric field alignment method of a ferroelectric liquid crystal display device according to the present invention. The aligning method under electric field of the ferroelectric liquid crystal and the liquid crystal display using the same according to the present invention, as shown in FIGS. 10 and 11, with respect to the liquid crystal panel 10 where the TFT is arranged in an offset configuration (i.e., zigzag pattern) along the data line direction, as shown in FIG. 17, makes floating or supplies the threshold voltage of the TFT between about 0˜1V. Then, during the electric field alignment period, the voltage transmitted by the data lines (D1 To Dm) is supplied to the ferroelectric liquid crystal cell C1c by the leakage current of TFT.

With respect to the ferroelectric liquid crystal cell C1c adjacent along the horizontal/vertical directions, as shown in FIGS. 15 and 16, the spontaneous polarization direction (PS) of the ferroelectric liquid crystal material becomes contrary to each other by the electric field alignment of the ferroelectric liquid crystal cell C1c by using the leakage current.

As described above, with respect to the electric field alignment method of the ferroelectric liquid crystal material according to the present invention, during the electric field alignment period, the TFTs arranged along the data line direction supply the data by a column inversion method to a liquid crystal panel connected to different data lines by each offset configuration line between adjacent two data lines and at the same time supplies the voltage set to a level higher than the turn-ON voltage of the TFT to the gate lines. As a result, the electric field alignment method of the ferroelectric liquid crystal material according to the present invention controls the polarity of the video data and supplies the driving circuit for displaying images upon the electric field alignment. Accordingly, the ferroelectric liquid crystal material may become aligned under the electric field and alignment of the ferroelectric liquid crystal material may be restore. Furthermore, because upon normal driving, an observer views the light through the long and short axis directions of the ferroelectric liquid crystal material of the adjacent liquid crystal cells irrespective of the viewing angle of the liquid crystal display device, the liquid crystal display aligned under electric field by the electric field alignment method can minimize color shifting.

It will be apparent to those skilled in the art that various modifications and variations can be made in the alignment method for ferroelectric liquid crystal material and liquid crystal display device using the same of the present invention without departing from the spirit or scope of the invention. Thus, it is intended that the present invention cover the modifications and variations of this invention provided they come within the scope of the appended claims and their equivalents.

What is claimed is:

1. An electric field alignment method of a ferroelectric liquid crystal display device, comprising:
connecting a plurality of thin film transistors arranged along a first direction to a plurality of data lines in an offset configuration between adjacent data lines;
supplying a turn-ON voltage at a level greater than a threshold voltage of the thin film transistors during an electric field alignment of ferroelectric liquid crystal material of the ferroelectric liquid crystal display device at least more than two successive times to a plurality of gate lines arranged along a second direction; and
supplying voltages of opposite polarity to the adjacent data lines during the electric field alignment while maintaining a voltage of a ferroelectric liquid crystal cell of the ferroelectric liquid crystal display device during the electric field alignment.

2. The electric field alignment method according to claim 1, wherein the ferroelectric liquid crystal cell operates in a Half V-Switching Mode.

3. The electric field alignment method according to claim 1, wherein supplying the turn-ON voltage to the gate lines is performed at least between ten to four-hundred times to the gate lines.

4. An electric field alignment method of a ferroelectric liquid crystal display device, comprising:
connecting a plurality of thin film transistors arranged along a first direction to a plurality of data lines arranging in an offset configuraton between adjacent data lines;
supplying a voltage below a threshold voltage of the thin film transistors to a plurality of gate lines during an electric field alignment of ferroelectric liquid crystal material of the ferroelectric liquid crystal display device; and
supplying voltages of opposite polarity to adjacent data lines during the electric field alignment while maintaining a voltage of a ferroelectric liquid crystal cell of the ferroelectic liquid crystal display device during the electric field alignment.

5. The electric field alignment method according to claim 4, wherein the ferroelectric liquid crystal cell operates in a Half V-Switching Mode.

6. The electric field alignment method according to claim 1, wherein supplying the voltage below the threshold voltage of the thin film transistors to the gate lines includes supplying a voltage between about 0˜1V to the gate lines during the electric field alignment.

7. An electric field alignment method of a ferroelectric liquid crystal display device, comprising:
connecting a plurality of thin film transistors arranged along a first direction to a plurality of data lines in an offset configuration adjacent data lines;
maintaining a plurality of gate lines in an electrically floating state during an electric field alignment of a ferroelectric liquid crystal material of the ferroelectric liquid crystal display device; and
supplying voltages of opposite polarity to the adjacent data lines during the electric field alignment while maintaining a voltage of a ferroelectric liquid crystal cell of the ferroelectric liquid crystal display device during the electric field alignment.

8. The electric field alignment method according to claim 7, wherein the ferroelectric liquid crystal cell operates in a Half V-Switching Mode.

9. A ferroelectric liquid crystal display device, comprising:
a liquid crystal panel having a plurality of data and gate lines and a plurality of thin film transistors arranged along a first direction in an offset configuration between adjacent data lines;
a gate driving circuit for supplying a turn-ON voltage at least more than two successive times to the plurality of gate lines, the turn-ON voltage set at a level above a threshold voltage of the thin film transistors during an electric field alignment of ferroelectric liquid crystal material; and
a data driving circuit for controlling opposite polarity voltages supplied to the adjacent data lines during the electric field alignment while maintaining a voltage supplied to ferroelectric liquid crystal cells during the electric field alignment.

10. The ferroelectric liquid crystal display device according to claim 9, wherein the ferroelectric liquid crystal cell operates in a Half V-Switching Mode.

11. The ferroelectric liquid crystal display device according to claim 9, wherein the gate driving circuit supplies the turn-ON voltage between ten and four-hundred times to the plurality of gate lines.

12. The ferroelectric liquid crystal display device according to claim 9, wherein the data driving circuit supplies video data having different polarities to the adjacent data lines during driving of the display device.

13. A ferroelectric liquid crystal display device, comprising:
a liquid crystal panel having a plurality of data and gate lines and a plurality of thin film transistors arranged along a first direction in an offset configuration between adjacent data lines;
a gate driving circuit for supplying a voltage below a threshold voltage of the thin film transistors to the gate lines during an electric field alignment of ferroelectric liquid crystal material of the display device; and
a data driving circuit for controlling opposite polarity voltages supplied to the adjacent data lines during the electric field alignment while maintaining a voltage supplied to a ferroelectric liquid crystal cell during the electric field alignment.

14. A ferroelectric liquid crystal display device, comprising:
a liquid crystal panel having a plurality of data and gate lines and a plurality of thin film transistors arranged along a first direction in an offset configuration between adjacent data lines; and
a data driving circuit for controlling opposite polarity voltages supplied to the adjacent data lines during an electric field alignment while maintaining a voltage supplied to a ferroelectric liquid crystal cell during the electric field alignment,
wherein the gate lines remain electrically floating during the electric field alignment.
